(19) United States
(12) Patent Application Publication
(10) Pub. No.: US 2012/0044050 A1
(43) Pub. Date: Feb. 23, 2012

(54) Smart Doorbell Security System and Method to Identify Visitors

(76) Inventors: Samir Vig, Rockville, MD (US); Shamila Vig, Rockville, MD (US)

(21) Appl. No.: 12/861,568

(22) Filed: Aug. 23, 2010

(51) Int. Cl. G05B 19/00

(52) U.S. Cl. 340/5.82

(57) ABSTRACT

A device and method to identify visitors and notify the resident of the identified information of the visitor before the resident opens the door for the visitor. The device reads/scans Visitor's Badge or Access Card which they use to activate the Smart Doorbell Switch by touching or swiping their badge or card on the Smart Doorbell Switch. Identifying information associated with the scanned Badge or Card is retrieved and announced for the Resident. Identification of the Badge or Card is also checked with an Alert Database to check if there is an alert tied to the Badge of Card. If so, the appropriate authorities will be contacted and the resident will be alerted.

### BACKGROUND OF THE INVENTION

In today's society, children and elderly are sometimes left unattended in their home or may under certain circumstances be faced with the decision of whether or not to approach and open the door when a doorbell rings. This system will allow them to be aware of exactly who is at the door and will enable them to decide if it is safe to open or if there is a stranger at the door. If parents do not want their children opening the door for strangers, they may explain to their children whom they can and cannot open the door for and as the speaker announces who is at the door, the children will know whether or not to approach the door. Parents will have the option of recording a custom announcement to be played back when different visitor's activate the Smart Doorbell Switch, making it easier to not only understand the message, but also clarify to children, and even elderly, who is safe to open the door for. If they know the person the Badge Information reader identified and they hear the name on the speaker, they may go to the door. If they do not know who is there, they do not need to open the door and don't even need to go near the door. They already know that they don't need to open it because it is not one of the people they are allowed to open the door for. If an employee of a service that visits home, such as package delivery, scans their badge, their name as well as their company information is saved, and will be played for the resident.

Another issue is visitors who are not welcome in a person's home. If someone is not welcome, the resident will not need to approach the door to see who it is. The unwelcomed guest will be announced as they ring the doorbell by scanning their badge or card and no one will come to the door because the resident will already know that there is no need to open the door. These guests can have the option of leaving a message if the resident wants to setup their system that way and there will be no need for the resident to first look outside to see who it is and possibly be seen and have to open the door. The resident also has the ability to mute the doorbell speaker. They may do this for individuals and groups that they do not wish to be disturbed by, or they may mute the speaker for certain hours of the day, such as nighttime, so they are not disturbed.

Another issue is that if there is an offender or convict at the door, the resident will not know until they open the door. This puts the resident at a great risk. Thus, there is a need for identifying a visitor at the Door and informing the resident of their identity to enable the resident to make a smart decision whether they should open the door for the visitor, take precaution, etc. This Smart Doorbell also has the ability to check an Alert Database to see if someone has an alert tied with their name. If a visitor has an alert tied to their name, the resident will be notified and they can then take proper action. If a visitor's alert is set to notify local authorities, the authorities will be contacted and if ordered to, they may arrive at the location of the Smart Doorbell. This ensures even greater safety for the resident, especially when dealing with safety of children and elderly.

### SUMMARY

Identification of the Badge or Card is also checked with an Alert Database to check if there is an alert tied to Badge of Card. If so, the appropriate authorities will be contacted and the resident will be alerted.

This is a device and method to identify visitors and notify the resident of the identified information of the visitor before the resident opens the door for the visitor. The device reads/scans Visitor's Badge or Access Card, hereinafter known as Badge, which they use to activate the Smart Doorbell Switch by touching or swiping their badge on the Smart Doorbell Switch. The term scanning used hereinafter means electronically reading the stripe on the badge, electronically reading the chip embedded on the card, reading the Bar Code on the card by using a Barcode Scanner or the like. Identifying information associated with the Scanned Badge is retrieved and announced for the Resident.

When the visitor activates the Smart Doorbell Switch, identifying information of the visitor encoded on the badge hereinafter known as Badge Information is captured by the Smart Doorbell Switch and transmitted to the Smart Doorbell. The received captured visitor Badge Information is compared with the stored Badge Information database to see if a match is found. If a match is found, information identifying the visitor is recited for the resident to inform the resident of the identifying information of the visitor. If there is no match found, a default message is recited for the resident. Visitor identifying information may also be saved directly on the Badge so their information is available wherever they go. This may be useful if a delivery person scans their badge because the resident can be notified that a delivery person is at the door. The badge may also carry alert information relevant to the visitor. If someone loses their badge, it may be deactivated by the issuer or actual owner. When a badge has no information on it or is de activated, a default message is played for the resident.

The resident is provided with the capability to scan and store Badge Information of the visitors they know, such as friends and family, locally in the Database in the Smart Doorbell. They may also save Badge Information on an external database, like the Central Server, located remote from the Smart Doorbell. The local Database of the Smart Doorbell can be physically installed in the Smart Doorbell, or, it can be on an external server in the vicinity of the property that is communicatively connected to the Smart Doorbell. The resident of the Smart Doorbell Security System may also scan and store the Badge Information of their employed or contracted service personnel such as the babysitter, cleaning personnel, lawn service personnel etc. in the Database. They may even create groups of people in their database and add all such personnel to the same group. The resident may also create a Block List of visitors who they would not like to see. When these visitors ring the bell and are identified by their Badge Information, the resident will be alerted, and also, if desired, the resident can configure the Smart Doorbell so that no bell rings inside the property. They may also set it so authorities are called and alerted when a preset visitor who is not welcome is visiting. The Smart Doorbell console inside the home or building will have a system that keeps a log of who rang the doorbell, on what day, and at what time. This is useful when no one is home and the resident wants to know who they missed. Additionally, the resident is provided with the capability of maintaining the Block List on the Central Server or some other remote server.

Additionally, the Smart Doorbell is further configured to transmit the Badge Information of the visitor to a Central Server which is configured to identify the Badge Information and transmit the identifying information associated with the Badge Information to the Smart Doorbell that provided that Badge Information. The Smart Doorbell is further adapted to then be able to store the Badge Information and its associated identifying information received from the Central Server in the Database.

If a Badge Information matches a previously saved visitor, the speaker will announce their name and inform the resident that the specific person has rung the bell. The Smart Doorbell console will consist of a screen, small keyboard, microphone and a speaker which allows the people inside to both see and hear the name. The screen and keyboard will also allow easier use of the Smart Doorbell and the microphone will allow recording of messages and announcements. It will also have a Database in place to perform certain functions such as storage of Badge Information, messages, and the log of visitors. The built in processor will help with the retrieval of Badge Information and its associated information, communication, and many other tasks requiring the Smart Doorbell to complete certain steps. The built in communication means encompasses a wide variety of tasks such as communication with local and remote servers, communication with authorities, connection between all components and other tasks involving communication with the Smart Doorbell. If the residents are not able to understand the information announced on the speaker, they can read the identifying information on the screen. Residents will be provided with an option to record their own pronunciation of a name and identifying information via the microphone. This will allow a better understanding of who is visiting and will allow customization of their announcements.

If a Badge's Information is not in the internal database, external databases may be searched. If there is no match in either database, the speaker will announce that there is an unidentified person at the door and it is up to the resident to decide whether or not to open the door. They can then save the Badge Information if they decide to do so. If there is an external match, their received identifying information will be recited and displayed for the resident. This visitor may then be saved internally for faster retrieval in the future and the ability to add more information and a custom saved announcement.

Additionally, the system is configured with the capability to perform a screening process to check if Badge Information is on an Alert Database. The Alert Database may include Badge Information and alerts from a large pool of sources and can include law enforcement, the government, proprietary, personal, and more. Authorities, service providers, residents and many others can update their Alert Lists on the Alert Database as needed. Each alert in the Alert Database can be coded with the identification of the authority who issued the alert. If a Badges Information is on an Alert Database, the resident will be warned and appropriate authorities will be notified.

The Smart Doorbell Switch is configured to allow the visitor to leave a message for the resident. When a visitor visits a property, and there is no one at the property, the visitor can leave a message for the resident using a microphone on the Smart Doorbell Switch. The residents will also be allowed to listen to the messages locally when they return to the property, or remotely by the resident calling into their account and using their user-id and password to listen to their messages. In addition, when no one is home, the Smart Doorbell is also equipped to be able to email, SMS, or call the resident with the identity of the visitor who is visiting and the time they visited the property. The resident may chose one or a combination of the three contact methods. The resident may also be notified via these means if they have received a message.

The components of the Smart Doorbell Security System can be configured in a variety of ways. For example, the Smart Doorbell Switch can also be configured to be communicatively connected to the Central Server. The Smart Doorbell Switch will transmit the scanned/read Badge Information and the identifying information of the Smart Doorbell to the server. After receiving the Badge Information, the Central Server identifies the visitor associated with the Badge Information and checks if the visitor is in an Alert Database. If a match is found in an Alert Database, the resident and the appropriate authority are alerted. The Central Server transmits the identifying information of the visitor and/or the alert message to the Smart Doorbell associated with the Smart Doorbell Switch from which the Badge Information was received.

For safety reasons as well as for convenience, each Smart Doorbell will have a user-id number and password. The resident of the Smart Doorbell will call a preset number, input their user-id and password, and then gain access to their account. They may also log into an online account with the same user-id and password. When someone logs into their account via phone call, they can perform a wide variety of tasks with ease such as set up which phones get the alert, what status they would like their machine to be (away, do not disturb, at home etc.), and they may listen to their messages. When someone logs in via the internet on a computer or similar device, many other tasks can be done with ease such as changing account and Smart Doorbell settings, account maintenance, Badge Information additions to the Database, and checking messages, among other tasks. This will allow easier setup of the device and can even allow sharing of one's information with someone else. If someone has a database of names and Badge Information that someone else would like, they can send the chosen names or all the names to the other account via the web. They may also share their own saved Badge Information and information with friends via the web. Each Smart Doorbell will have an online account and can be logged into via the user-id and password. This also helps people with multiple homes because they can completely merge their accounts or just share certain information. The Smart Doorbell and Smart Doorbell Switch can be set up so that people can scan their own badge at their residence and/or wherever they are given permission, and the door will be unlocked.

Another feature associated with this Smart Doorbell is an external speaker and microphone for the Smart Doorbell Switch. This can be used not only for communication with the person inside if the resident feels the need to setup a talk, but also for relaying a message to visitors. The resident can use a setting in which they can leave a message for only certain people or for everyone. When someone rings the Doorbell, and this option is turned on, they will be identified and if they are on the list of people who the message is meant for, a message will be played to them. If the message is made for everyone, it will be played to everyone. The resident can also make groups on their device so that they can easily put in a setting related to the people of that group or record a message for those people when they are not home. The speaker may also be used to inform the visitor of their options when ringing the bell and giving them steps of how to do certain things, such as leave a message. The Smart Doorbell Switch's scanner is what captures the Badge Information of the visitors and it has communication means which allow it to communicate not only internally but externally. Optionally, there may also be buttons added for ease of use when dealing with leaving messages, going through the prompts from the speaker, and other tasks. An option for unidentified visitors is the ability to speak into an external microphone and announce who they are. The resident will have the option of shutting on and off the speaker when the external microphone is in use.

This device has many features which can be setup to tailor it to the specific needs of the resident. The setup can take into account need levels for things like privacy and security and it can be tailored to meet those needs. Another option the device will have is the ability to turn the speaker on and off if the resident does not want to be disturbed and set hours during which time they do not want to be disturbed, such as weekday nights, so that the speaker automatically goes mute during those hours. If someone rings the bell during those hours, no ring and message will come from the speakers, and they will be saved in the log for future viewing. If they wish, the resident may give the visitor the option of stating that their visit is an emergency and the bell will ring.

The resident will also have the option of installing connected speakers and/or small screens throughout the home to ensure better coverage of the announcement and the ability to check/ make changes to the Smart Doorbell.

### BRIEF DESCRIPTION OF DIAGRAMS

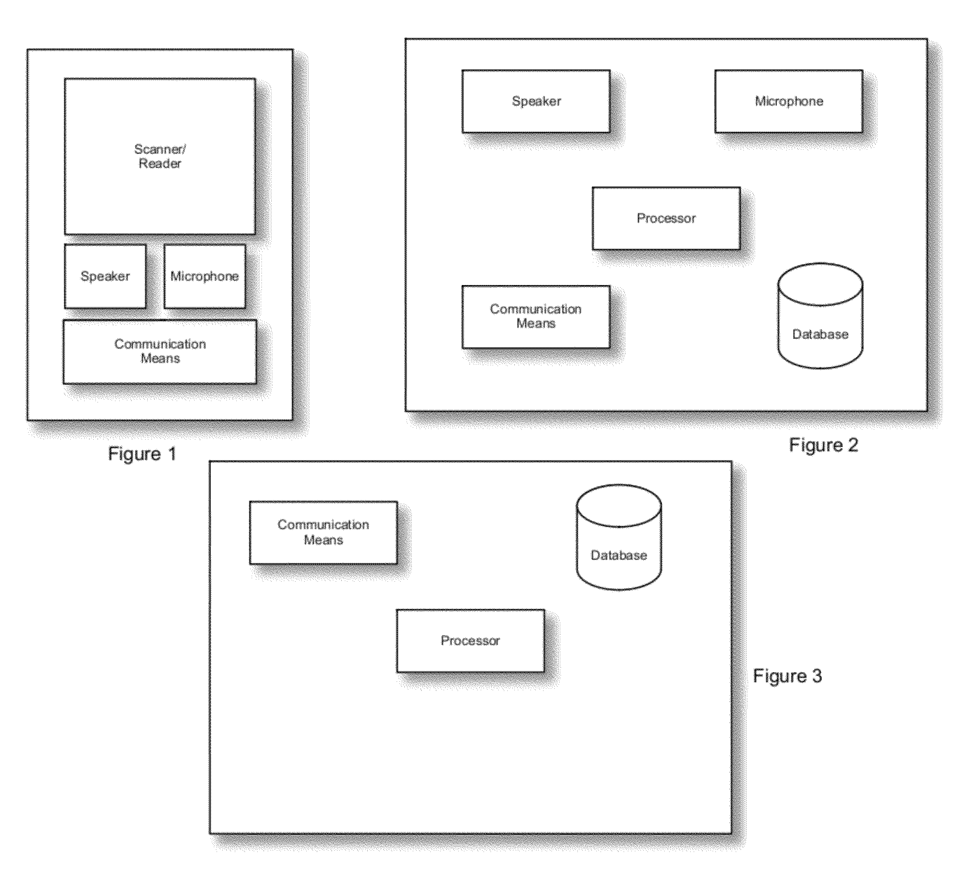

FIG. 1: A diagram of the Smart Doorbell Switch

FIG. 2: A diagram of the Smart Doorbell

FIG. 3: A diagram of the Central Server

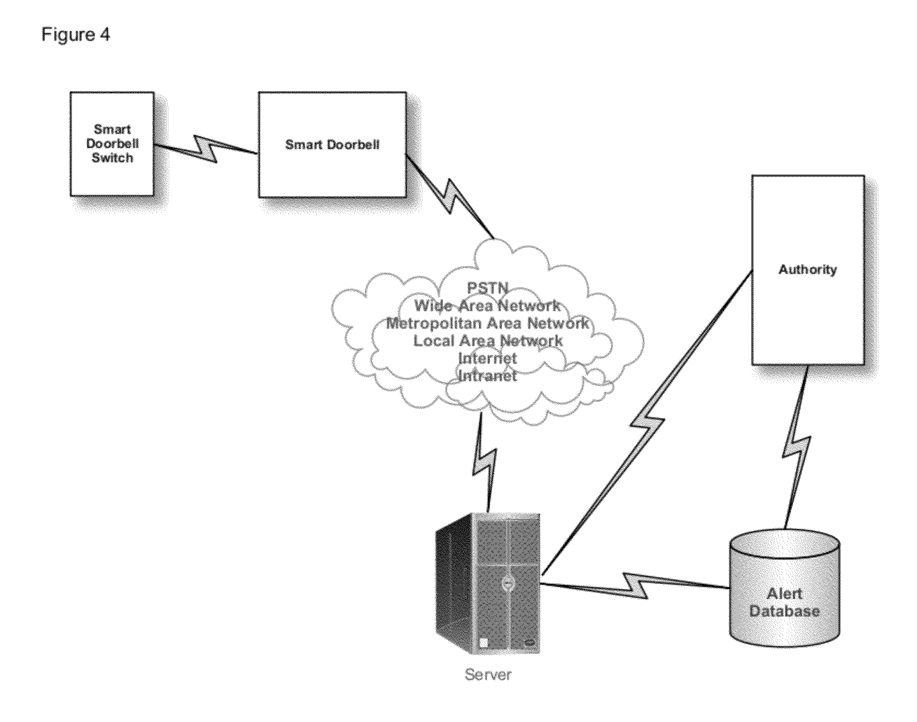

FIG. 4: A diagram of an option for the Smart Doorbell Network in which the Smart Doorbell Switch connects to the Smart Doorbell which then is connected to the Central Server which is connected to the Alert Database and Authorities.

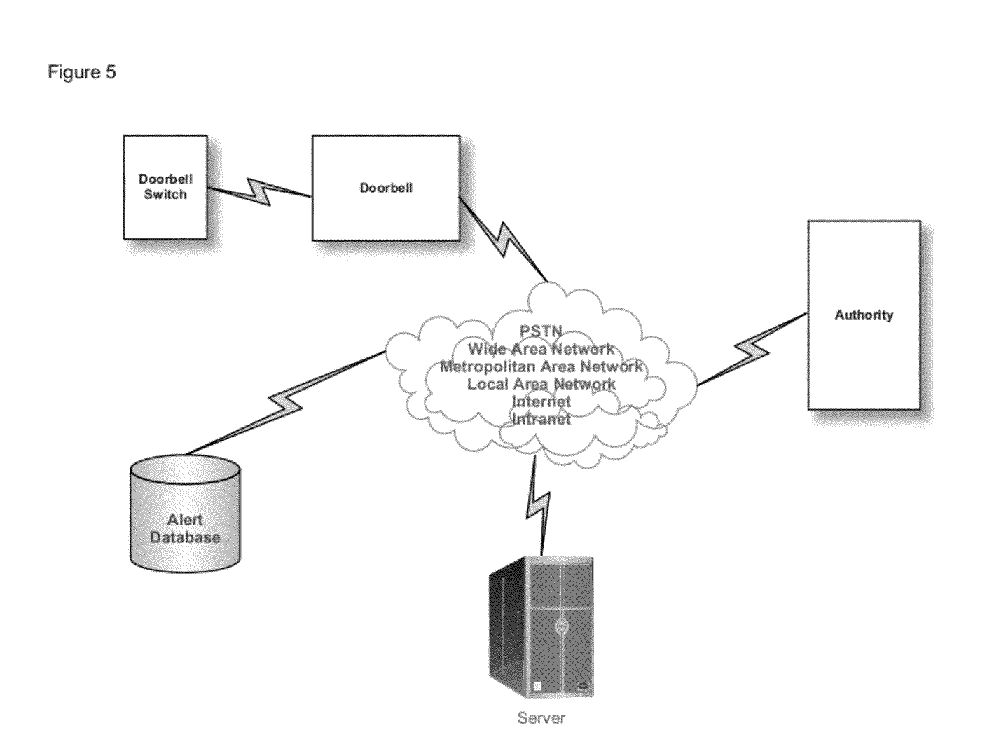

FIG. 5: A diagram of an option for the Smart Doorbell Network in which the Smart Doorbell Switch Connects to the Smart Doorbell which is then connected to the Alert Database, Server, and Authorities.

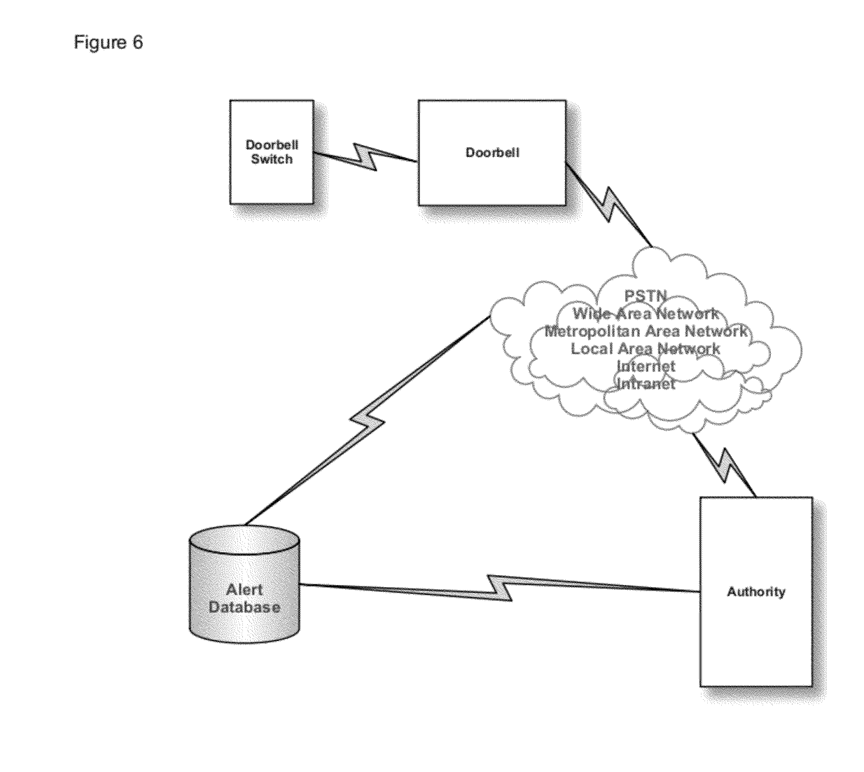

FIG. 6: A diagram of an option for the Smart Doorbell Network in which the Smart Doorbell Switch Connects to the Smart Doorbell which is then connected to the Alert Database and Authorities.

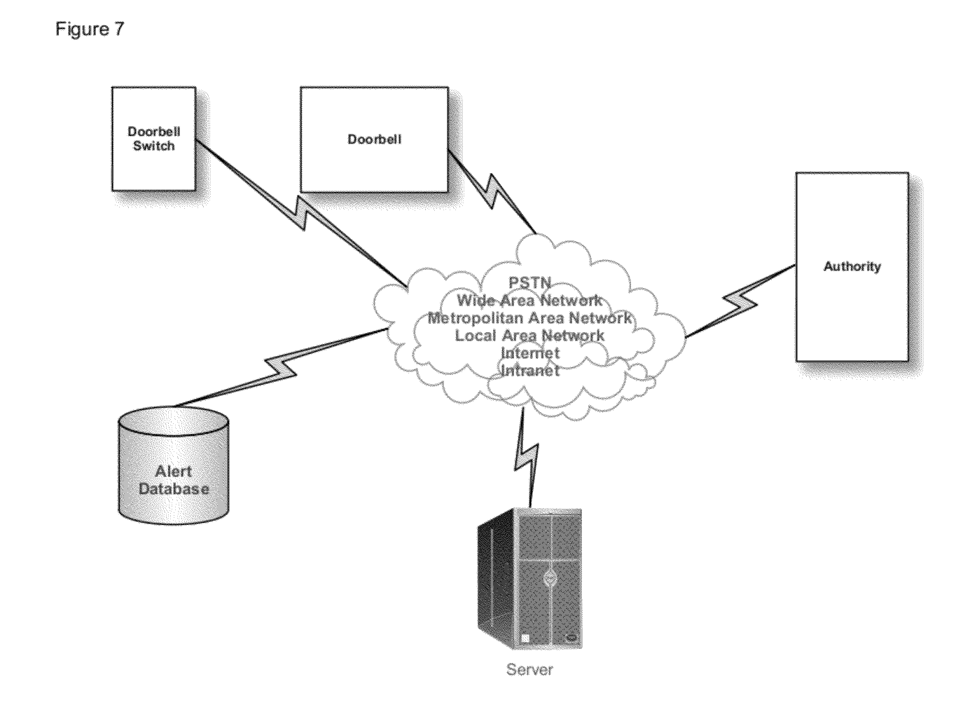

FIG. 7: A diagram of an option for the Smart Doorbell Network in which a connection is direct between the Smart Doorbell Switch, the Smart Doorbell, and the Central Server. The Doorbell and Central Server are also able to connect to the Alert Database and Authorities as well as each other.

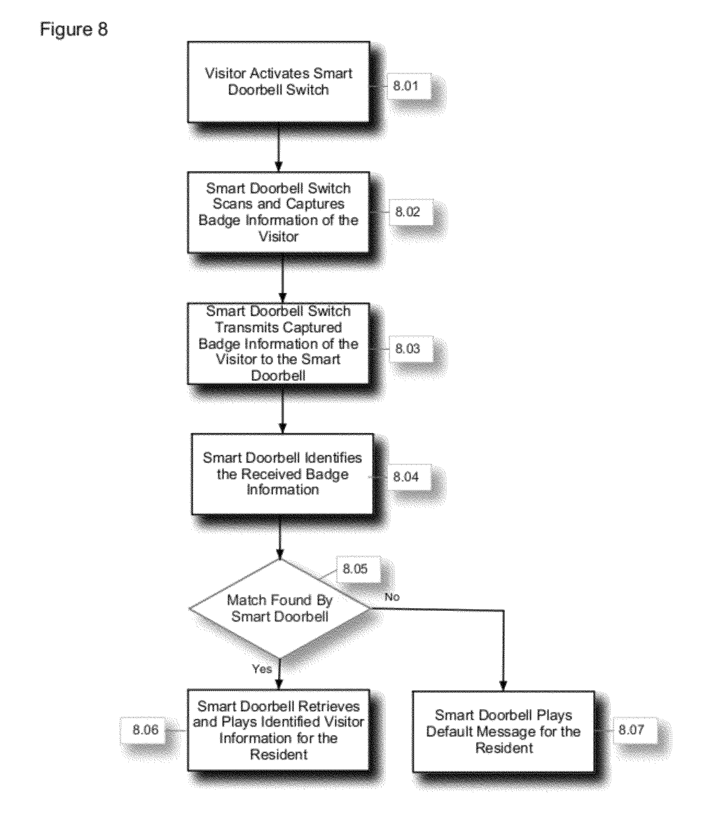

FIG. 8: A flow chart in which the Smart Doorbell Switch is activated, the Badge Information is scanned, transmitted to the Smart Doorbell, compared to the local database for a match and then a message is played for the resident.

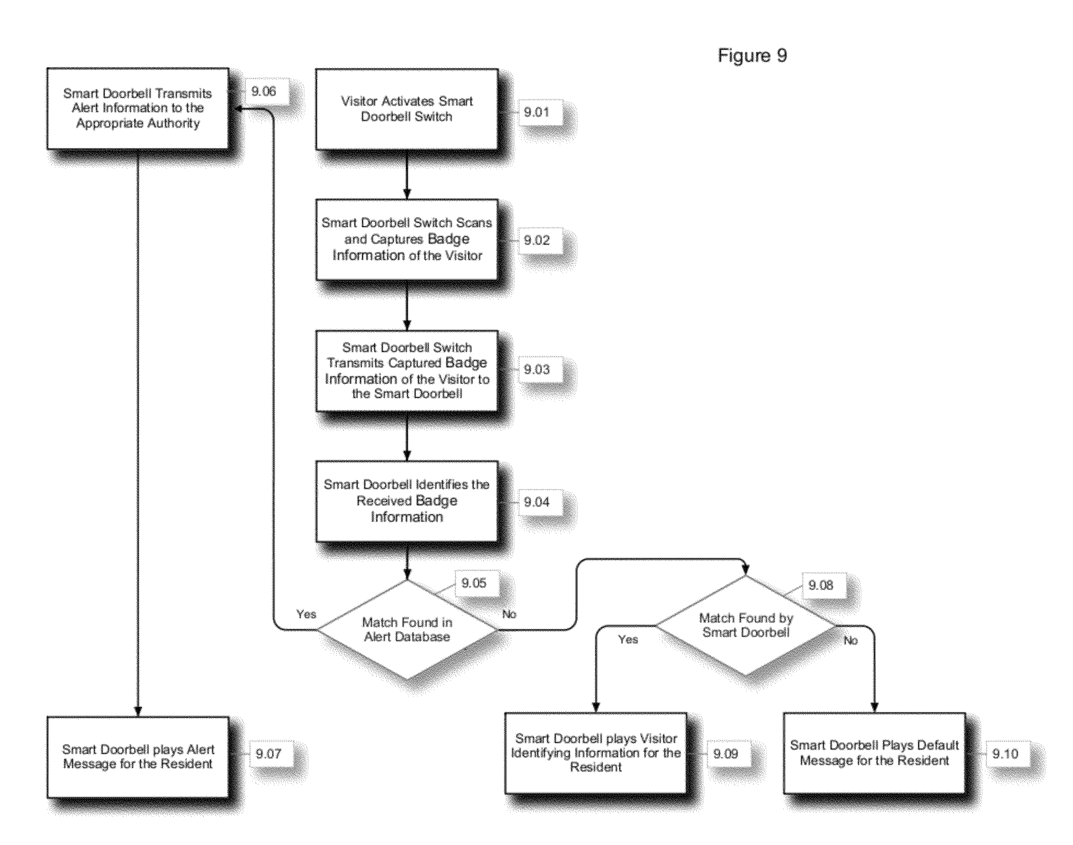

FIG. 9: A flow chart in which the Smart Doorbell Switch is activated, the Badge Information is scanned, transmitted to the Smart Doorbell, compared to the Alert Database for a match, then depending on the outcome, compared to the local database for a match, and in the end depending on the end outcome, a message is played for the resident.

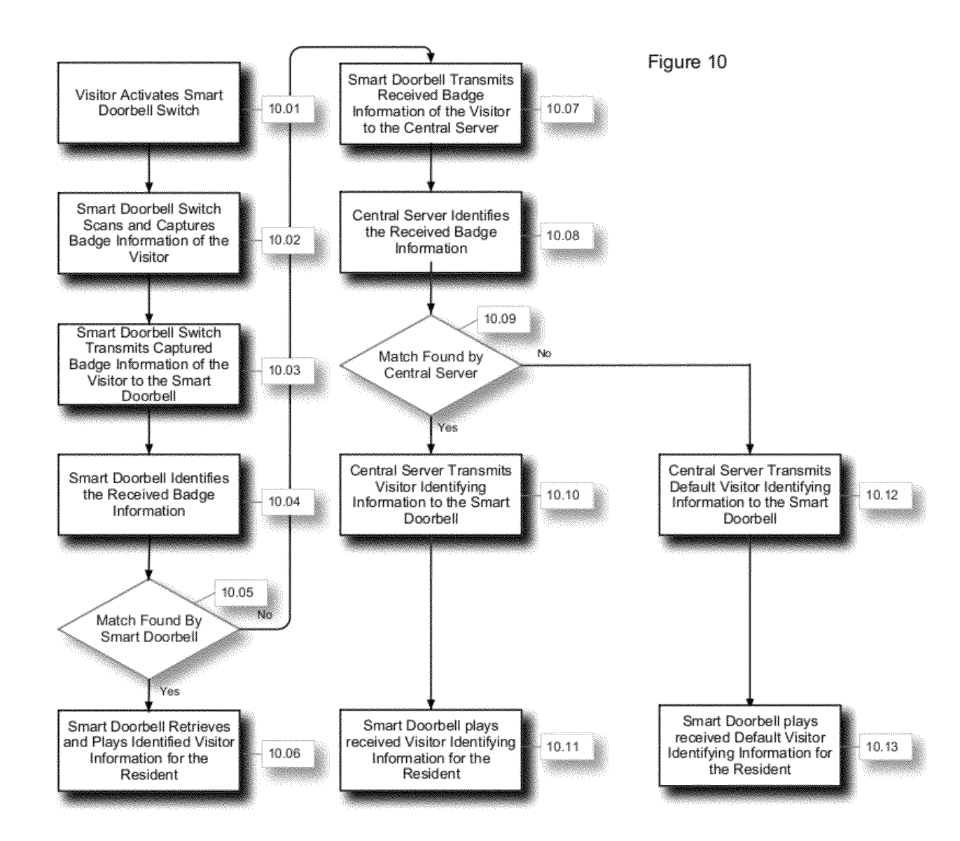

FIG. 10: A flow chart in which the Smart Doorbell Switch is activated, the Badge Information is scanned, transmitted to the Smart Doorbell, compared to the local database for a match, then depending on the outcome, a message is played with identifying information, or, a Central Server is transmitted the Badge Information. Depending on if the Central Server finds a match, either a default message or message containing the identifying information is played for the resident from the Smart Doorbell.

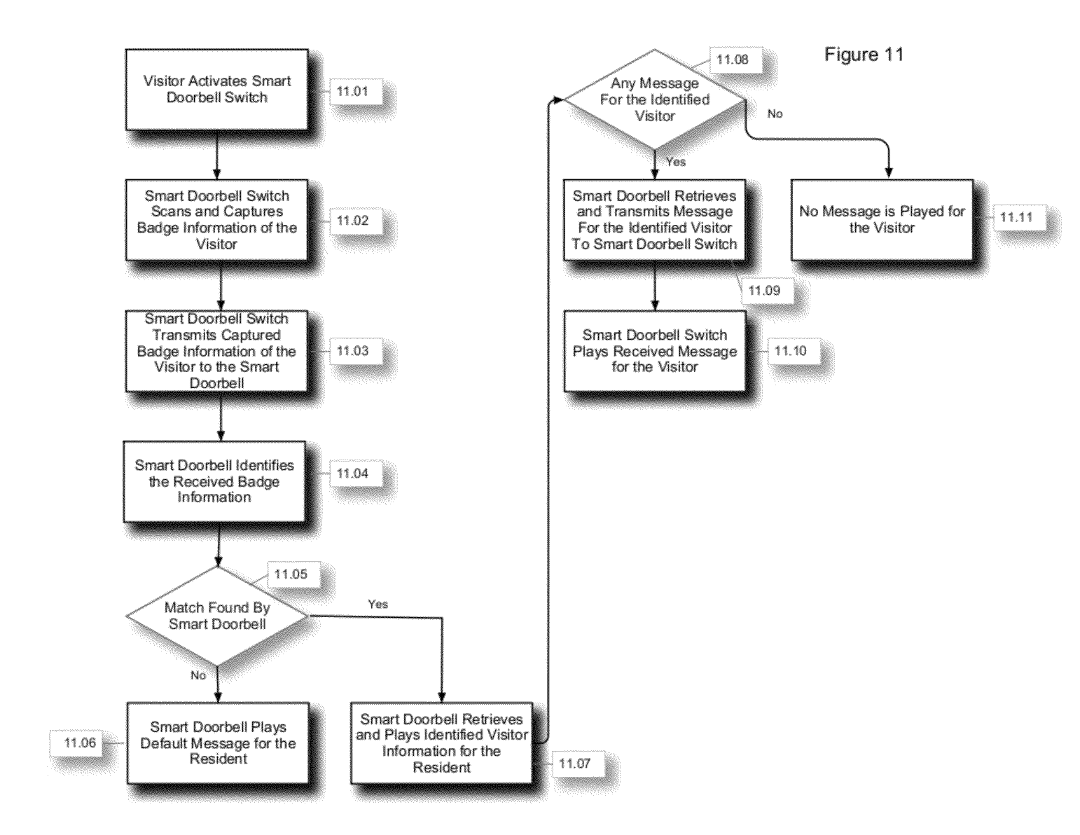

FIG. 11: A flow chart in which the Smart Doorbell Switch is activated, the Badge Information is scanned, transmitted to the Smart Doorbell, compared to the local database for a match and then a message is played for the resident. After the resident receives the message, the Smart Doorbell searches for any messages the resident saved for the visitor. If a message is saved, it is transmitted to the Smart Doorbell Switch and played for the visitor.

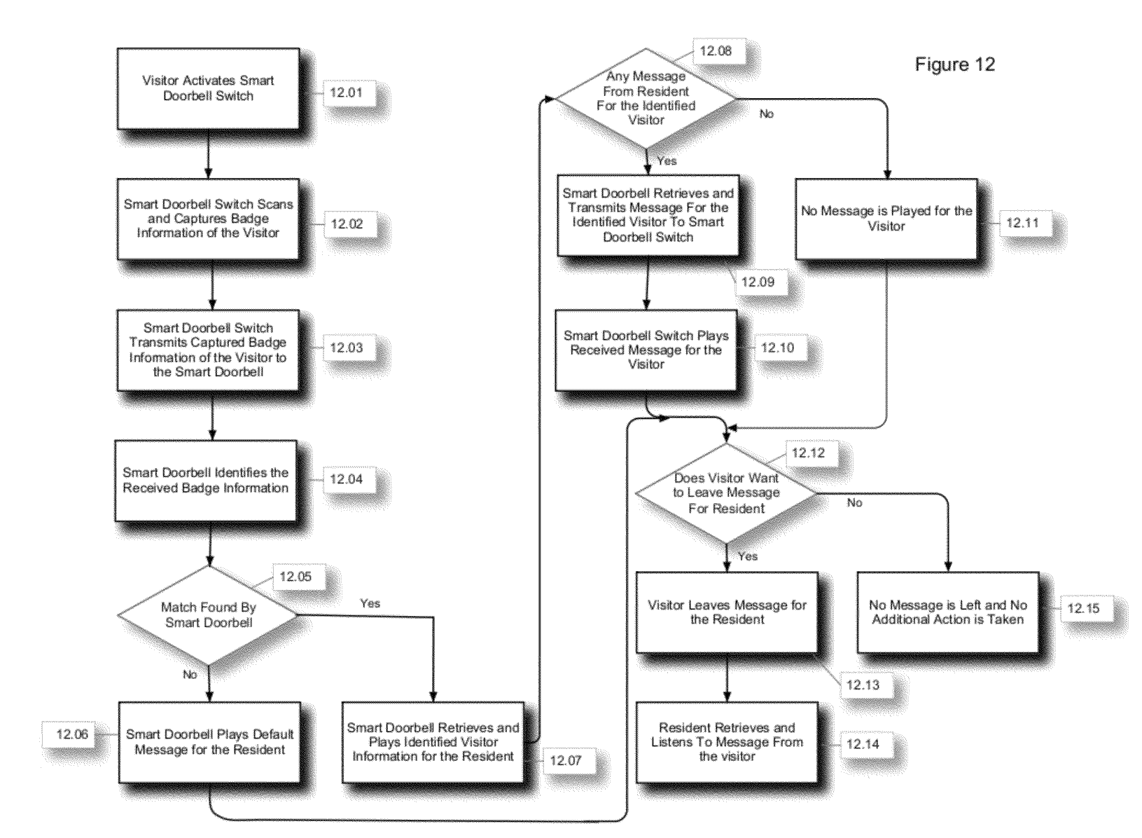

FIG. 12: A flow chart in which the Smart Doorbell Switch is activated, the Badge Information is scanned, transmitted to the Smart Doorbell, compared to the local database for a match and then a message is played for the resident. After the resident receives the message, the Smart Doorbell searches for any messages the resident saved for the visitor. If a message is saved, it is transmitted to the Smart Doorbell Switch and played for the visitor. At the end of this process, the visitor is given an option to leave a message for the resident.

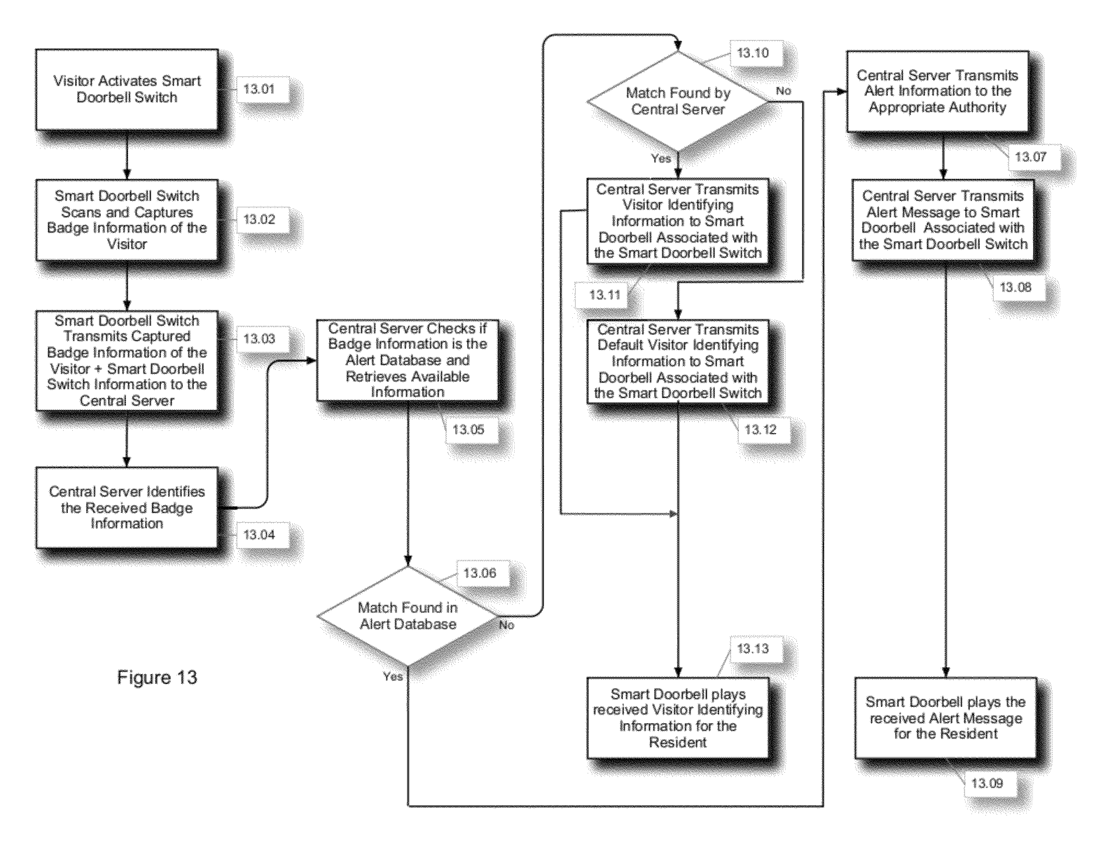

FIG. 13: A flow chart in which the Smart Doorbell Switch is activated, the Badge Information is scanned, and then transmitted along with Smart Doorbell Switch information to the Central Server. The Central Server checks if the Badge Information is in an Alert Database, and if a match is found, Alert information is sent to the appropriate authority and an alert message is sent to the Smart Doorbell to be played. If no alert is found in the Alert Database, the Central Server is checked for a matching identity for the Badge Information and depending on the outcome, a message is played for the resident from the Smart Doorbell.

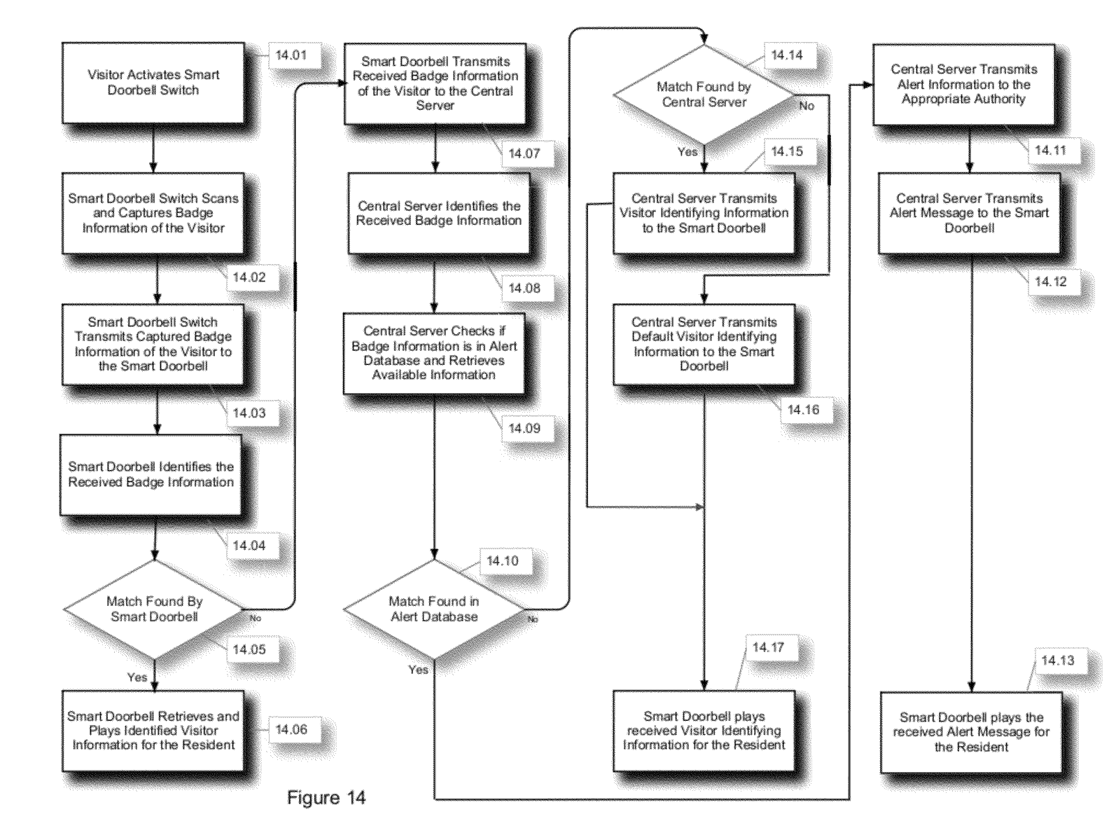

FIG. 14: A flow chart in which the Smart Doorbell Switch is activated, the Badge Information is scanned, transmitted to the Smart Doorbell, compared to the local database for a match, then depending on the outcome, a message is played with identifying information or a Central Server is transmitted the Badge Information. If the Central Server is sent the Badge Information, the Alert Database checked. If a match is found, Alert information is sent to the appropriate authority and an alert message is sent to the Smart Doorbell to be played. If no alert is found in the Alert Database, the Central Server is checked for a matching identity for the Badge Information and depending on the outcome, a message is played for the resident from the Smart Doorbell.

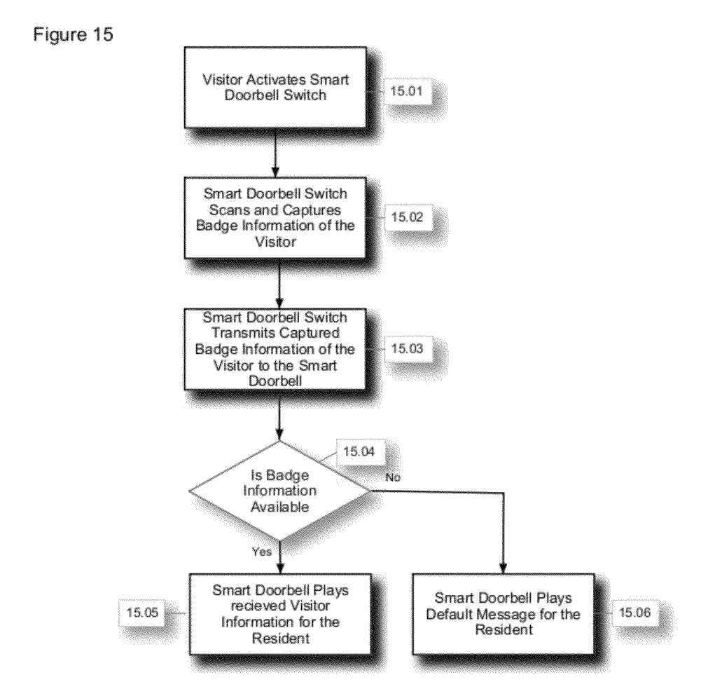

FIG. 15: A flow chart in which the Smart Doorbell Switch is activated, the Badge Information is scanned, transmitted to the Smart Doorbell, a message containing visitor identity is played if there is information received from the Badge and a default message is played if there is no information available on the badge.

### DESCRIPTION OF DIAGRAMS

### FIG. 1

A diagram showing the Smart Doorbell Switch. The Smart Doorbell Switch is preferably powered by a power source such as a battery pack in the Smart Doorbell Switch, direct connection to the home or office's power, or power is received from the Smart Doorbell. The Smart Doorbell Switch communicates with the Smart Doorbell and the Central Server using wired or wireless communication means. The Smart Doorbell Switch has a scanner configured to scan the Badge Information of the visitor. When a visitor comes to the premises and activates the Smart Doorbell Switch by placing their badge on the scanner, the scanner is set to scan and/or read the Badge Information of the visitor. The Smart Doorbell Switch also transmits the Badge Information of the visitor to the Smart Doorbell or whatever other destination it is set to report to or send the Badge Information to send to. The Badge Information Scanner can also be magnetic reader, an Optical Scanner, a Capacitance Scanner, smart card reader or any other technology that best suites the Smart Doorbell Switch. This may also include technology in which a transmitter transmits a signal from a badge in your pocket so that when the visitor is within a certain range from the Smart Doorbell switch, the receiver in the Smart Doorbell Switch will capture the signal and saved information from the badge. Optionally, the Smart Doorbell Switch can be equipped with a speaker to announce messages for the visitor and it can also be equipped with a microphone to enable the visitor to leave a message for the resident. Optionally, the Smart Doorbell Switch may also be equipped with buttons to allow the visitor to communicate with the Smart Doorbell Switch or Smart Doorbell as they please. For example, there may be a button to leave a message or a button for replaying a message or prompt. Additionally, the Smart Doorbell Switch can optionally be equipped with a camera to capture the image of the visitor and transmit it the Smart Doorbell for display for the resident.

### FIG. 2

A diagram showing the Smart Doorbell. The Smart Doorbell is preferably powered by a power source such as a battery pack in the Smart Doorbell, or an external power source. The Smart Doorbell communicates with the Smart Doorbell Switch, Alert Database, Authorities, and the Central Server using wired or wireless communication means. The Smart Doorbell also communicates, through wired connection or wirelessly, to an online account through which maintenance, database updates, and other functions may be done. There is also connectivity via a phone number that prompts you to input a user-id and password. A personal computer and scanner may be used to add visitor Badge Information and their identifying information to the database. Optionally, a screen and input method, such as a keyboard, may be added to the Smart Doorbell to allow maintenance and database additions directly from the Smart Doorbell. This Screen will also allow visitor identifying information be displayed incase the resident does not clearly hear the bell. Additionally, the display screen can be configured on the Smart Doorbell to display the image of the visitor received from Smart Doorbell Switch. The Smart Doorbell's communication means also includes the ability to communicate via SMS, calls, voicemails, emails and other modes for situations where the away from home option is set. The Communication Means of the Smart Doorbell allows communication between the Smart Doorbell and anything it needs communication with, including but not limited to the entire Smart Doorbell Security System. The Smart Doorbell contains a processor adapted to identify the received scan of the Badge Information and notify the resident of the identity of the visitor. It also helps analyze and process all other tasks that are needed to be done in the Smart Doorbell. Optionally, the Smart Doorbell is further equipped to transmit the received Badge Information to a central server for the identification of the visitor, and notification to the resident of the identity of the visitor by using the identifying information received from the central server. Additionally, the Smart Doorbell can be further configured to access an Alert Database to determine whether the received Badge Information is on an Alert Database. If it is determined that the Badge Information is on an Alert Database, the Smart Doorbell alerts the resident about the visitor and can send an alert message to the appropriate authority informing them of the location of the Smart Doorbell and the information about the visitor. Optionally, the Smart Doorbell can also be equipped with a microphone to enable the resident to leave messages for visitors. Residents may leave messages for both people saved in their Database and for those that are not. However, due to the dangers associated with leaving messages for strangers, the resident will be given a warning when they try leaving a message for people who visit that are not in their Database. The microphone may also optionally be provided to record a resident's own notification in their voice to be played from the Smart Doorbell when a certain visitor visits. These custom notifications may be recorded for each Badge Information entry in the database. It may also be equipped with a Speaker to allow announcements be made to the resident. These announcements include anything that needs to be played to the resident such as visitor identifying information, messages, and alerts. The resident may also set their Smart Doorbell to go mute during certain hours when they do not wish to be disturbed. This can be set for any length of time and the resident may give visitors during those hours an option to state that it is an emergency and the speaker will un mute. The resident may also create groups for their saved Badge Information in the Database and the resident may mute doorbell announcements for single people and groups if they do not wish to see them. They may also set people in their Database to have a special alert so that the authority is called when they try to ring the bell. Optionally, the alerting messages, along with all other messages, can be locally stored in the Smart Doorbell. In this case, the central server sends an id of the alerting message, or regular message, to the Smart Doorbell and that is what is announced for the resident. For example, message 1=“Fugitive at the Door, Please do not open the door and take proper shelter”; message 2=“authorities have been informed, Fugitive at the Door, Please do not open the door and take proper shelter”, etc. When the Smart Doorbell receives the identifying id of the message, that is what is played and the whole message does not need to be sent to the Smart Doorbell. This minimizes the bandwidth used for transmitting the message because the id of the message is transmitted to the Smart Doorbell, and the Smart Doorbell retrieves the message related to the message id it received and plays it for the resident. The Smart Doorbell is also equipped with a Database. The Database is where Badge Information are stored along with all other information associated with those Badge Information. The Database can also be used for storing saved playback messages, log of visitors, saved visitor messages, and anything else that may need to be saved both permanently and temporarily. The Smart Doorbell has the ability keep a log of all visitors whose Badge Information were scanned at the door. If the visitor's information is available, it will be stored with the Badge Information in the log. If the visitor cannot be identified, just their Badge Information will be saved with a note stating that its identity could not be found.

### FIG. 3

A diagram showing the Central Server. The Central Server can communicate with the Smart Doorbell, Smart Doorbell Switch, Alert Database, and Authorities using wired or wireless communication means. It also communicates, through wired connection or wirelessly, to other sources to update and add to its database and for a variety of other reasons. The Central Server contains a processor adapted to identify the received scan of the Badge Information from a Smart Doorbell. It transmits the identifying information associated with the received Badge Information to the Smart Doorbell from which the Badge Information was received. The Central Server is equipped and set to maintain a database of Badge Information and associated identifying information. In addition, the Central Server processor is further adapted to determine whether the received Badge Information is in an Alert Database by accessing the Alert Database maintained internally, by accessing an external Alert Database, or a combination of both. If it is determined that the received Badge Information is in an Alert Database, the Central Server transmits alert information to the Smart Doorbell and sends an alert message to the authority informing them of the identifying information of the visitor and the location of the Smart Doorbell, among other important information.

### FIG. 4

This diagram illustrates an option for the Smart Doorbell Network with the Smart Doorbell Switch communicatively connected to the Smart Doorbell and the Smart Doorbell communicatively connected to the Central Server which is communicatively connected to the Alert Database and Authorities. After the Smart Doorbell receives the Badge Information from the Smart Doorbell Switch, it is preferred that the Smart Doorbell processes the received Badge Information to identify the visitor using its database. Alternatively, the Smart Doorbell can transmit the received Badge Information to the Central Server for the identification of the visitor. The Central Server is communicatively linked to the Smart Doorbell, the Alert Database, and a wide range of authorities. The Central Server processor processes the received Badge Information to identify the visitor and transmit the identifying information to the Smart Doorbell from which the Badge Information was received. Also, the Central Processor is further configured to determine whether the received Badge Information is in an Alert Database by accessing the external Alert Database as well as the internally saved Alert Database. When it is determined that the Badge Information is in an Alert Database, the Central Server transmits alert information, which is comprised of at least identifying information of the visitor and information of the Smart Doorbell from which the Badge Information was received, to the appropriate authority. Another message is sent to the Smart Doorbell, from which the Badge Information was received, to alert the residents about the possibly dangerous visitor and situation.

### FIG. 5

This diagram illustrates an option for the Smart Doorbell Network with the Smart Doorbell Switch is communicatively connected to the Smart Doorbell and the Smart Doorbell is communicatively connected to the Alert Database, Central Server, and Authorities. After the Smart Doorbell receives the Badge Information from the Smart Doorbell Switch, it is preferred that the Smart Doorbell processes the received Badge Information to identify the visitor using its database. Alternatively, the Smart Doorbell can transmit the received Badge Information to the Central Server for the identification of the visitor. The Central Server processor processes the received Badge Information to identify the visitor and transmits the identifying information to the Smart Doorbell from which the Badge Information was received. When it is determined that the Badge Information is in the Alert Database, the Central Server may transmit the alert information, which is comprised of at least identifying information of the visitor and information of the Smart Doorbell from which the Badge Information was received, to the appropriate authority. Another message is sent to the Smart Doorbell, from which the Badge Information was received, to alert the residents about the possibly dangerous visitor and situation. Also, the Smart Doorbell can be configured to directly check if a Badge Information is in the Alert Database. When it is determined that the Badge Information is in the Alert Database, the Smart Doorbell may transmit alert information, which is comprised of at least identifying information of the visitor and information of the Smart Doorbell from which the Badge Information was received, to the appropriate authority.

### FIG. 6

This diagram illustrates an option for the Smart Doorbell Network with the Smart Doorbell Switch communicatively connected to the Smart Doorbell and the Smart Doorbell communicatively connected to the Alert Database and the Authorities. After the Smart Doorbell receives the Badge Information from the Smart Doorbell Switch, it is configured so that the Smart Doorbell processes the received Badge Information to identify the visitor using its database. Also, the Smart Doorbell is further configured to determine whether the received Badge Information is in the Alert Database. When it is determined that the Badge Information is in the Alert Database, the Smart Doorbell transmits alert information, which is comprised of at least identifying information of the visitor and information of the Smart Doorbell from which the Badge Information was received, to the appropriate authority. The Smart Doorbell then alerts the residents about the possibly dangerous visitor and situation.

### FIG. 7

This diagram illustrates an option for the Smart Doorbell Network with the Smart Doorbell Switch communicatively connected to the Smart Doorbell and the Central Server. The Smart Doorbell is communicatively connected to the Alert Database, Central Server, and Authorities. After the Smart Doorbell receives the Badge Information from the Smart Doorbell Switch, it is preferred that the Smart Doorbell processes the received Badge Information to identify the visitor using its database. Alternatively, the Smart Doorbell can transmit the received Badge Information to the Central Server for the identification of the visitor. The Central Server processor processes the received Badge Information to identify the visitor and transmits the identifying information to the Smart Doorbell from which the Badge Information was received. When it is determined that the Badge Information is in the Alert Database, the Central Server may transmit the alert information, which is comprised of at least identifying information of the visitor and information of the Smart Doorbell from which the Badge Information was received, to the appropriate authority. Another message is sent to the Smart Doorbell, from which the Badge Information was received, to alert the residents about the possibly dangerous visitor and situation. Also, the Smart Doorbell can be configured to directly check if a Badge Information is in the Alert Database. When it is determined that the Badge Information is in the Alert Database, the Smart Doorbell may transmit alert information, which is comprised of at least identifying information of the visitor and information of the Smart Doorbell from which the Badge Information was received, to the appropriate authority. Alternatively, after the Smart Doorbell Switch captures the Badge Information, it may transmit the Badge Information of the visitor and the identification of the Smart Doorbell associated with the Smart Doorbell Switch directly to the Central Server. Central Server processor processes the received Badge Information to identify the visitor and transmits the identifying information to the Smart Doorbell from which the Badge Information was received. When it is determined that the Badge Information is in the Alert Database, the Central Server may transmit the alert information, which is comprised of at least identifying information of the visitor and information of the Smart Doorbell from which the Badge Information was received, to the appropriate authority. Another message is sent to the Smart Doorbell, from which the Badge Information was received, to alert the residents about the possibly dangerous visitor and situation.

### FIG. 8

### 8.01: Visitor Activates Smart Doorbell Switch

The visitor may activate the Smart Doorbell Switch in a variety of ways. When the visitor gently presses/touches the Smart Doorbell Switch with their badge or slides their card, the Smart Doorbell Switch is activated and triggered to take further action. Badge information can be saved by the issuer who can be a resident, property manager, employer, government agency etc. The Badge Information can be personal, proprietary and/or public. The Badge Information can be saved on a Badge Information Database on a local or remote servers.

### 8.02: Smart Doorbell Switch Scans and Captures Badge Information of the Visitor

Once the Smart Doorbell Switch is activated by the visitor placing their badge on the Smart Doorbell Switch or sliding their card, the visitor's Badge Information is then scanned and captured by the finger reader.

### 8.03: Smart Doorbell Switch Transmits Captured Badge Information of the Visitor to the Smart Doorbell

After the Smart Doorbell Switch has scanned the Badge and captured information from the Badge, the Smart Doorbell Switch transmits the captured Badge Information to the Smart Doorbell.

### 8.04: Smart Doorbell Identifies the Received Badge Information

When the Smart Doorbell receives the Badge Information from the Smart Doorbell Switch, the Smart Doorbell searches its in-house database to find a match for the received Badge Information. This in-house database is made up of previous Badge Information that were saved by the resident. The resident has an option of having their database viewable in an online account. This online account is connected to their Smart Doorbell and has all their Badge Information along with any saved information. The resident may edit entries in their database through this system if they do not wish to do it from their Smart Doorbell console. They also have the option of sending or receiving entries. If someone has an entry that someone else hasn't made yet, they may send them that entry. By doing so, they will get that entry's saved Badge Information and whatever saved information the sender wishes to share. Using the online account, people may also send their own Badge Information and associated identifying information so that others have it in their database. If someone has multiple homes, they may link all of their Smart Doorbells via an online account. The online account eases the process of making a database of Badge Information and allows sharing of entries. It may also be used for maintenance of the Smart Doorbell and for changing settings of the Smart Doorbell if the resident does not wish to use the Smart Doorbell console.

### 8.05: Results of the In-House Database Search are Analyzed to Determine the Next Step.

If a Badge Information match is found between the visitor and the in-house database:

### 8.06: Smart Doorbell Retrieves and Plays Identified Visitor Information for the Resident

If a Badge Information match is found in the in-house Badge Information database, the Smart Doorbell retrieves the saved information of the visitor associated with the identified Badge Information. The Smart Doorbell then notifies the resident at the premise of who is at the door by reciting the retrieved identifying information of the visitor. The resident has the option of setting the Smart Doorbell to keep a log of all visitors. When a match is found in the in-house database, the log will keep track of the information retrieved as well as what time and on what day that visitor was there. This can be useful for security purposes or for informing the premise resident of who visited their premise when they were away. The premise resident will have an option of turning on an alert system to inform them, via SMS, email, or phone call, of who visited their premise while they were away. They may also choose to have any combination of the three. If the resident is away and they set the alert function on, when someone rings the bell, an alert will instantly be sent, via whatever means was chosen, to the resident or resident's who are away.

If a Badge Information match is not found between the visitor and the in-house database:

### 8.07: Smart Doorbell Plays Default Message for the Resident

When identifying information is not found in the in-house database, the Smart Doorbell notifies the resident of the unidentified visitor by reciting a default message. This default message will not only announce that someone is at the door but also that they are not able to be identified by the saved visitor database. The resident then has the option of saving that Badge Information in their database. This will allow faster identification of that visitor next time they visit. If no one is home and they have set the alert function on, the resident will be notified via whatever means they have chosen that an unidentified visitor was at the door. The Badge Information will still be saved in the log if that option is set.

### FIG. 9

### 9.01: Visitor Activates Smart Doorbell Switch

The visitor may activate the Smart Doorbell Switch in a variety of ways. When the visitor gently presses/touches the Smart Doorbell Switch with their badge or slides their card, the Smart Doorbell Switch is activated and triggered to take further action. Badge information can be saved by the issuer who can be a resident, property manager, employer, government agency etc. The Badge Information can be personal, proprietary and/or public. The Badge Information can be saved on a Badge Information Database on a local or remote servers.

### 9.02: Smart Doorbell Switch Scans and Captures Badge Information of the Visitor

Once the Smart Doorbell Switch is activated by the visitor placing their badge on the Smart Doorbell Switch or sliding their card, the visitor's Badge Information is then scanned and captured by the finger reader.

### 9.03: Smart Doorbell Switch Transmits Captured Badge Information of the Visitor to the Smart Doorbell

After the Smart Doorbell Switch has scanned the Badge and captured information from the Badge, the Smart Doorbell Switch transmits the captured Badge Information to the Smart Doorbell.

### 9.04: Smart Doorbell Identifies the Received Badge Information

When the Smart Doorbell receives the Badge Information from the Smart Doorbell Switch, the Smart Doorbell searches its in-house database to find a match for the received Badge Information. This in-house database is made up of previous Badge Information that were saved by the resident. The resident has an option of having their database viewable in an online account. This online account is connected to their Smart Doorbell and has all their Badge Information along with any saved information. The resident may edit entries in their database through this system if they do not wish to do it from their Smart Doorbell console. They also have the option of sending or receiving entries. If someone has an entry that someone else hasn't made yet, they may send them that entry. By doing so, they will get that entry's saved Badge Information and whatever saved information the sender wishes to share. Using the online account, people may also send their own Badge Information and associated identifying information so that others have it in their database. If someone has multiple homes, they may link all of their Smart Doorbells via an online account. The online account eases the process of making a database of Badge Information and allows sharing of entries. It may also be used for maintenance of the Smart Doorbell and for changing settings of the Smart Doorbell if the resident does not wish to use the Smart Doorbell console.

### 9.05: Results of the Alert Database Check are Analyzed to Determine the Next Step.

If a Badge Information match is found between the visitor and the Alert Database:

### 9.06: Smart Doorbell Transmits Alert Information to the Appropriate Authority

When a match is found between the visitor's Badge Information and the Alert Database, the Smart Doorbell sends an Alert Message to the appropriate authority associated with the alert. This Alert Message will include, at a minimum, the visitor's alert information, the time they pressed the Smart Doorbell, and the address associated with the Smart Doorbell at which the Badge Information was scanned. For example: If a visitor is in the FBI wanted list, an Alert Message is sent to the FBI telling them that the identified person who is in their wanted list is at the address associated with the Smart Doorbell they activated at whatever time they are there. If a person is wanted or dangerous, their Alert profile in the Alert Database can be set so that the appropriate local authorities will be contacted to ensure safety and possible capture.

### 9.07: Smart Doorbell Plays Alert Message for the Resident

Once a match is found between a Badge Information and the Alert Database, an Alert Message is played for the resident. The resident should then act accordingly. If the resident is away and they have set the away from residence alert function on, they will be contacted with the alert by whatever means they have chosen (phone, email, SMS etc.) and will know not to return immediately and to do so with caution when they do return. If for any reason the resident wishes to save the Badge Information of the visitor if they are not already saved, they may do so, however, they will get a warning message from their Smart Doorbell first stating that there is an alert for that visitor. If the resident is away, they will also have the ability to save the Badge Information when they return. The Badge Information will still be saved in the log if the log option is set.

If a Badge Information match is not found between the visitor and the Alert Database:

### 9.08: Results of the In-House Database Search are Analyzed to Determine the Next Step.

If a Badge Information match is found between the visitor and the in-house database:

### 9.09: Smart Doorbell Plays Visitor Identifying Information for the Resident

If a Badge Information match is found in the in-house Badge Information database and they are not on the Alert Database, the Smart Doorbell retrieves the saved information of the visitor associated with the identified Badge Information. The Smart Doorbell then notifies the resident at the premise of who is at the door by reciting the retrieved identifying information of the visitor. The visitor will be added to the log if that option is set on the Smart Doorbell. When a match is found in the in-house database, the log will keep track of the information retrieved as well as what time and on what day that visitor was there. This can be useful for security purposes or for informing the premise resident of who visited their premise when they were away. The premise resident will have an option of turning on an alert system to inform them, via SMS, email, or phone call, of who visited their premise while they were away. They may also choose to have any combination of the three. If the resident is away and they set the alert function on, when someone rings the bell, an alert with the visitors information will instantly be sent, via whatever means was chosen, to the resident or resident's who are away.

If a Badge Information match is not found between the visitor and the in-house database:

### 9.10: Smart Doorbell Plays Default Message for the Resident

When the visitor is not on the Alert Database and identifying information is not found in the in-house database, the Smart Doorbell notifies the resident of the unidentified visitor by reciting a default message. This default message will not only announce that someone is at the door but also that they are not able to be identified by the saved visitor database. The resident then has the option of saving that Badge Information in their database. This will allow faster identification of that visitor next time they visit. If no one is home and they have set the alert function on, the resident will be notified via whatever means they have chosen that an unidentified visitor was at the door. The Badge Information will still be saved in the log if that option is set.

FIG. 10

### 10.01: Visitor Activates Smart Doorbell Switch

The visitor may activate the Smart Doorbell Switch in a variety of ways. When the visitor gently presses/touches the Smart Doorbell Switch with their badge or slides their card, the Smart Doorbell Switch is activated and triggered to take further action. Badge information can be saved by the issuer who can be a resident, property manager, employer, government agency etc. The Badge Information can be personal, proprietary and/or public. The Badge Information can be saved on a Badge Information Database on a local or remote servers.

### 10.02: Smart Doorbell Switch Scans and Captures Badge Information of the Visitor

Once the Smart Doorbell Switch is activated by the visitor placing their badge on the Smart Doorbell Switch or sliding their card, the visitor's Badge Information is then scanned and captured by the finger reader.

### 10.03: Smart Doorbell Switch Transmits Captured Badge Information of the Visitor to the Smart Doorbell

After the Smart Doorbell Switch has scanned the Badge and captured information from the Badge, the Smart Doorbell Switch transmits the captured Badge Information to the Smart Doorbell.

### 10.04: Smart Doorbell Identifies the Received Badge Information

When the Smart Doorbell receives the Badge Information from the Smart Doorbell Switch, the Smart Doorbell searches its in-house database to find a match for the received Badge Information. This in-house database is made up of previous Badge Information that were saved by the resident. The resident has an option of having their database viewable in an online account. This online account is connected to their Smart Doorbell and has all their Badge Information along with any saved information. The resident may edit entries in their database through this system if they do not wish to do it from their Smart Doorbell console. They also have the option of sending or receiving entries. If someone has an entry that someone else hasn't made yet, they may send them that entry. By doing so, they will get that entry's saved Badge Information and whatever saved information the sender wishes to share. Using the online account, people may also send their own Badge Information and associated identifying information so that others have it in their database. If someone has multiple homes, they may link all of their Smart Doorbells via an online account. The online account eases the process of making a database of Badge Information and allows sharing of entries. It may also be used for maintenance of the Smart Doorbell and for changing settings of the Smart Doorbell if the resident does not wish to use the Smart Doorbell console.

10.05: Results of the in-house database search are analyzed to determine the next step.

If a Badge Information match is found between the visitor and the in-house database:

### 10.06: Smart Doorbell Retrieves and Plays Identified Visitor Information for the Resident

If a Badge Information match is found in the in-house Badge Information database, the Smart Doorbell retrieves the saved information of the visitor associated with the identified Badge Information. The Smart Doorbell then notifies the resident at the premise of who is at the door by reciting the retrieved identifying information of the visitor. The resident has the option of setting the Smart Doorbell to keep a log of all visitors. When a match is found in the in-house database, the log will keep track of the information retrieved as well as what time and on what day that visitor was there. This can be useful for security purposes or for informing the premise resident of who visited their premise when they were away. The premise resident will have an option of turning on an alert system to inform them, via SMS, email, or phone call, of who visited their premise while they were away. They may also choose to have any combination of the three. If the resident is away and they set the alert function on, when someone rings the bell, an alert will instantly be sent, via whatever means was chosen, to the resident or resident's who are away.

If a Badge Information match is not found between the visitor and the in-house database:

### 10.07: Smart Doorbell Transmits Received Badge Information of the Visitor to the Central Server

If no match is found by the Smart Doorbell, the Smart Doorbell transmits the received Badge Information to the central server which contains a database comprised of data from a wide genre of agencies such as Government agencies, private companies, and security providing agencies. People may also send their Badge Information and identifying information to this central server via their online account so that when they ring a Smart Doorbell, their information is available. These agencies can provide their Badge Information and associated person information.

### 10.08: Central Server Identifies the Received Badge Information

The central server looks for a match for the received Badge Information in its database.

### 10.09: Results of the Central Server Badge Information Database Check are Analyzed to Determine the Next Step.

If a Badge Information match is found between the visitor and the Central Server:

### 10.10: Central Server Transmits Visitor Identifying Information to the Smart Doorbell

When a match is found on the Central Server, the Central Server transmits the identifying information tied with the received Badge Information to the Smart Doorbell that sent that Badge Information.

### 10.11: Smart Doorbell Plays Received Visitor Identifying Information for the Resident

If identifying information is found on the Central Server in relation to a Badge Information, it is given to the resident. The Smart Doorbell notifies the resident of who is at the door by reciting the received information as well as telling them that the visitor was identified by the Central Server. The resident then has the option of saving that Badge Information in their database. This will allow faster identification of that visitor next time they visit. The Badge Information will still be saved in the log if that option is set. If no one is home and they have set the alert function on, the resident will be notified via whatever means they have chosen. They will be able to save the Badge Information in the database when they return home if they know the visitor and are comfortable with giving them an entry.

If a Badge Information match is not found between the visitor and the Central Server:

### 10.12: Central Server Transmits Default Visitor Identifying Information to the Smart Doorbell

When a match is not found on the Central Server, the Central Server transmits a default message to the Smart Doorbell that sent that Badge Information. The default message will state that the visitor cannot be identified via the in-house database or via the Central Server.

### 10.13: Smart Doorbell Plays Received Default Visitor Identifying Information for the Resident

When identifying information is not found on the Central Server or the in-house database, the Smart Doorbell notifies the resident of the unidentified visitor by reciting the default message once it is received. The resident then has the option of saving that Badge Information in their database. This will allow faster identification of that visitor next time they visit. If no one is home and they have set the alert function on, the resident will be notified via whatever means they have chosen that an unidentified visitor was at the door. The Badge Information will still be saved in the log if that option is set.

### FIG. 11

### 11.01: Visitor Activates Smart Doorbell Switch

The visitor may activate the Smart Doorbell Switch in a variety of ways. When the visitor gently presses/touches the Smart Doorbell Switch with their badge or slides their card, the Smart Doorbell Switch is activated and triggered to take further action. Badge information can be saved by the issuer who can be a resident, property manager, employer, government agency etc. The Badge Information can be personal, proprietary and/or public. The Badge Information can be saved on a Badge Information Database on a local or remote servers.

### 11.02: Smart Doorbell Switch Scans and Captures Badge Information of the Visitor

Once the Smart Doorbell Switch is activated by the visitor placing their badge on the Smart Doorbell Switch or sliding their card, the visitor's Badge Information is then scanned and captured by the finger reader.

### 11.03: Smart Doorbell Switch Transmits Captured Badge Information of the Visitor to the Smart Doorbell

After the Smart Doorbell Switch has scanned the Badge and captured information from the Badge, the Smart Doorbell Switch transmits the captured Badge Information to the Smart Doorbell.

### 11.04: Smart Doorbell Identifies the Received Badge Information

When the Smart Doorbell receives the Badge Information from the Smart Doorbell Switch, the Smart Doorbell searches its in-house database to find a match for the received Badge Information. This in-house database is made up of previous Badge Information that were saved by the resident. The resident has an option of having their database viewable in an online account. This online account is connected to their Smart Doorbell and has all their Badge Information along with any saved information. The resident may edit entries in their database through this system if they do not wish to do it from their Smart Doorbell console. They also have the option of sending or receiving entries. If someone has an entry that someone else hasn't made yet, they may send them that entry. By doing so, they will get that entry's saved Badge Information and whatever saved information the sender wishes to share. Using the online account, people may also send their own Badge Information and associated identifying information so that others have it in their database. If someone has multiple homes, they may link all of their Smart Doorbells via an online account. The online account eases the process of making a database of Badge Information and allows sharing of entries. It may also be used for maintenance of the Smart Doorbell and for changing settings of the Smart Doorbell if the resident does not wish to use the Smart Doorbell console.

### 11.05: Results of the In-House Database Search are Analyzed to Determine the Next Step.

If a Badge Information match is not found between the visitor and the in-house database:

### 11.06: Smart Doorbell Plays Default Message for the Resident

When identifying information is not found in the in-house database, the Smart Doorbell notifies the resident of the unidentified visitor by reciting a default message. This default message will not only announce that someone is at the door but also that they are not able to be identified by the saved visitor database. The resident then has the option of saving that Badge Information in their database. This will allow faster identification of that visitor next time they visit. If no one is home and they have set the alert function on, the resident will be notified via whatever means they have chosen that an unidentified visitor was at the door. The Badge Information will still be saved in the log if that option is set.

If a Badge Information match is found between the visitor and the in-house database:

### 11.07: Smart Doorbell Retrieves and Plays Identified Visitor Information for the Resident

If a Badge Information match is found in the in-house Badge Information database, the Smart Doorbell retrieves the saved information of the visitor associated with the identified Badge Information. The Smart Doorbell then notifies the resident at the premise of who is at the door by reciting the retrieved identifying information of the visitor. The resident has the option of setting the Smart Doorbell to keep a log of all visitors. When a match is found in the in-house database, the log will keep track of the information retrieved as well as what time and on what day that visitor was there. This can be useful for security purposes or for informing the premise resident of who visited their premise when they were away. The premise resident will have an option of turning on an alert system to inform them, via SMS, email, or phone call, of who visited their premise while they were away. They may also choose to have any combination of the three. If the resident is away and they set the alert function on, when someone rings the bell, an alert will instantly be sent, via whatever means was chosen, to the resident or resident's who are away.

### 11.08: Results of the Saved Message Search for the Identified Visitor are Analyzed to Determine the Next Step.

If a saved message is found for the visitor in the in-house database:

### 11.09: Smart Doorbell Retrieves and Transmits Message for the Identified Visitor to Smart Doorbell Switch

Residents are able to go through their saved visitor database and select anywhere from one to all of the people in their database to leave a message for. Residents may leave a message if they are out, in the residence and unavailable, or for any other reason they may see fit. They select the recipients, record the desired message, and set the Smart Doorbell to play the message. After a match is found in the in-house visitor database for a visitor, their account is searched for any saved messages by the resident. If a saved message is found for that visitor, the Smart Doorbell will retrieve that message and transmit it to the Smart Doorbell Switch that the visitor activated.

### 11.10: Smart Doorbell Switch Plays Received Message for the Visitor

After the Smart Doorbell Switch receives the transmitted message from the Smart Doorbell, it plays the message for the visitor to hear.

If a saved message is not found for the visitor in the in-house database:

### 11.11: No Message is Played for the Visitor

If no message is found for the visitor, no message is transmitted from the Smart Doorbell to the Smart Doorbell Switch and no message is played.

### FIG. 12

### 12.01: Visitor Activates Smart Doorbell Switch

The visitor may activate the Smart Doorbell Switch in a variety of ways. When the visitor gently presses/touches the Smart Doorbell Switch with their badge or slides their card, the Smart Doorbell Switch is activated and triggered to take further action. Badge information can be saved by the issuer who can be a resident, property manager, employer, government agency etc. The Badge Information can be personal, proprietary and/or public. The Badge Information can be saved on a Badge Information Database on a local or remote servers.

### 12.02: Smart Doorbell Switch Scans and Captures Badge Information of the Visitor

Once the Smart Doorbell Switch is activated by the visitor placing their badge on the Smart Doorbell Switch or sliding their card, the visitor's Badge Information is then scanned and captured by the finger reader.

### 12.03: Smart Doorbell Switch Transmits Captured Badge Information of the Visitor to the Smart Doorbell

After the Smart Doorbell Switch has scanned the Badge and captured information from the Badge, the Smart Doorbell Switch transmits the captured Badge Information to the Smart Doorbell.

### 12.04: Smart Doorbell Identifies the Received Badge Information

When the Smart Doorbell receives the Badge Information from the Smart Doorbell Switch, the Smart Doorbell searches its in-house database to find a match for the received Badge Information. This in-house database is made up of previous Badge Information that were saved by the resident. The resident has an option of having their database viewable in an online account. This online account is connected to their Smart Doorbell and has all their Badge Information along with any saved information. The resident may edit entries in their database through this system if they do not wish to do it from their Smart Doorbell console. They also have the option of sending or receiving entries. If someone has an entry that someone else hasn't made yet, they may send them that entry. By doing so, they will get that entry's saved Badge Information and whatever saved information the sender wishes to share. Using the online account, people may also send their own Badge Information and associated identifying information so that others have it in their database. If someone has multiple homes, they may link all of their Smart Doorbells via an online account. The online account eases the process of making a database of Badge Information and allows sharing of entries. It may also be used for maintenance of the Smart Doorbell and for changing settings of the Smart Doorbell if the resident does not wish to use the Smart Doorbell console.

### 12.05: Results of the In-House Database Search are Analyzed to Determine the Next Step.

If a Badge Information match is not found between the visitor and the in-house database:

### 12.06: Smart Doorbell Plays Default Message for the Resident

When identifying information is not found in the in-house database, the Smart Doorbell notifies the resident of the unidentified visitor by reciting a default message. This default message will not only announce that someone is at the door but also that they are not able to be identified by the saved visitor database. The resident then has the option of saving that Badge Information in their database. This will allow faster identification of that visitor next time they visit. If no one is home and they have set the alert function on, the resident will be notified via whatever means they have chosen that an unidentified visitor was at the door. The Badge Information will still be saved in the log if that option is set.

### 12.12: Result of Visitor's Decision to Leave a Message is Analyzed to Determine the Next Step.

If the visitor wants to leave a message for the resident:

### 12.13: Visitor Leaves Message for the Resident

If the visitor chooses to leave a message by pushing the message button, they may do so by following the Smart Doorbell Switch's prompted instructions. After listening to the prompted instructions, they will then be prompted to speak into a built in microphone. They will be able to record anything they want up to the message time limit that is set by the resident. After their message is complete, they will push the end button and the message will be saved. Once it is saved, the message is sent to the Smart Doorbell.

12.14: Resident Retrieves and Listens to Message from the Visitor

If a message is saved from a visitor, the resident may retrieve and listen to it in a variety of ways. They may check their messages from their online account, from their Smart Doorbell console, or by calling into a preset number and logging in with their pre set log in information. If the alert function is on, not only will the resident get a notification that there was an unidentified visitor, but also another notification that a message was received.

If the visitor does not want to leave a message for the resident:

### 12.15: No Message is Left and No Additional Action is Taken

If the visitor chooses not to leave a message by refraining from pushing the message button, no prompt will be played and no additional action will be taken.

If a Badge Information match is found between the visitor and the in-house database:

### 12.07: Smart Doorbell Retrieves and Plays Identified Visitor Information for the Resident

If a Badge Information match is found in the in-house Badge Information database, the Smart Doorbell retrieves the saved information of the visitor associated with the identified Badge Information. The Smart Doorbell then notifies the resident at the premise of who is at the door by reciting the retrieved identifying information of the visitor. The resident has the option of setting the Smart Doorbell to keep a log of all visitors. When a match is found in the in-house database, the log will keep track of the information retrieved as well as what time and on what day that visitor was there. This can be useful for security purposes or for informing the premise resident of who visited their premise when they were away. The premise resident will have an option of turning on an alert system to inform them, via SMS, email, or phone call, of who visited their premise while they were away. They may also choose to have any combination of the three. If the resident is away and they set the alert function on, when someone rings the bell, an alert will instantly be sent, via whatever means was chosen, to the resident or resident's who are away.

### 12.08: Results of the Saved Message Search for the Identified Visitor are Analyzed to Determine the Next Step.

If a saved message is found for the visitor in the in-house database:

### 12.09: Smart Doorbell Retrieves and Transmits Message for the Identified Visitor to Smart Doorbell Switch

Residents are able to go through their saved visitor database and select anywhere from one to all of the people in their database to leave a message for. Residents may leave a message if they are out, in the residence and unavailable, or for any other reason they may see fit. They select the recipients, record the desired message, and set the Smart Doorbell to play the message. After a match is found in the in-house visitor database for a visitor, their account is searched for any saved messages by the resident. If a saved message is found for that visitor, the Smart Doorbell will retrieve that message and transmit it to the Smart Doorbell Switch that the visitor activated.

### 12.10: Smart Doorbell Switch Plays Received Message for the Visitor

After the Smart Doorbell Switch receives the transmitted message from the Smart Doorbell, it plays the message for the visitor to hear.

### 12.12: Result of Visitor's Decision to Leave a Message is Analyzed to Determine the Next Step.

If the visitor wants to leave a message for the resident:

### 12.13: Visitor Leaves Message for the Resident

After hearing the message left for them, if the visitor chooses to leave a message by pushing the message button, they may do so by following the Smart Doorbell Switch's prompted instructions. After listening to the prompted instructions, they will then be prompted to speak into a built in microphone. They will be able to record anything they want up to the message time limit that is set by the resident. After their message is complete, they will push the end button and the message will be saved. Once it is saved, the message is sent to the Smart Doorbell.

12.14: Resident Retrieves and Listens to Message from the Visitor

If a message is saved from a visitor, the resident may retrieve and listen to it in a variety of ways. They may check their messages from their online account, from their Smart Doorbell console, or by calling into a preset number and logging in with their pre set log in information. If the alert function is on, not only will the resident get a notification that there was a visitor, but also another notification that a message was received. The notification that a message was received will also include the visitor's information when it is available from the database.

If the visitor does not want to leave a message for the resident:

### 12.15: No Message is Left and No Additional Action is Taken

If the visitor chooses not to leave a message by refraining from pushing the message button, no prompt will be played and no additional action will be taken.

If a saved message is not found for the visitor in the in-house database:

### 12.11: No Message is Played for the Visitor

If no message is found for the visitor, no message is transmitted from the Smart Doorbell to the Smart Doorbell Switch and no message is played.

### 12.12: Result of Visitor's Decision to Leave a Message is Analyzed to Determine the Next Step.

If the visitor wants to leave a message for the resident:

### 12.13: Visitor Leaves Message for the Resident

If the visitor chooses to leave a message by pushing the message button, they may do so by following the Smart Doorbell Switch's prompted instructions. After listening to the prompted instructions, they will then be prompted to speak into a built in microphone. They will be able to record anything they want up to the message time limit that is set by the resident. After their message is complete, they will push the end button and the message will be saved. Once it is saved, the message is sent to the Smart Doorbell.

12.14: Resident Retrieves and Listens to Message from the Visitor

If a message is saved from a visitor, the resident may retrieve and listen to it in a variety of ways. They may check their messages from their online account, from their Smart Doorbell console, or by calling into a preset number and logging in with their pre set log in information. If the alert function is on, not only will the resident get a notification that there was a visitor, but also another notification that a message was received. The notification that a message was received will also include the visitor's information when it is available from the database.

If the visitor does not want to leave a message for the resident:

### 12.15: No Message is Left and No Additional Action is Taken

If the visitor chooses not to leave a message by refraining from pushing the message button, no prompt will be played and no additional action will be taken.

### FIG. 13

### 13.01: Visitor Activates Smart Doorbell Switch

The visitor may activate the Smart Doorbell Switch in a variety of ways. When the visitor gently presses/touches the Smart Doorbell Switch with their badge or slides their card, the Smart Doorbell Switch is activated and triggered to take further action. Badge information can be saved by the issuer who can be a resident, property manager, employer, government agency etc. The Badge Information can be personal, proprietary and/or public. The Badge Information can be saved on a Badge Information Database on a local or remote servers.

### 13.02: Smart Doorbell Switch Scans and Captures Badge Information of the Visitor

Once the Smart Doorbell Switch is activated by the visitor placing their badge on the Smart Doorbell Switch or sliding their card, the visitor's Badge Information is then scanned and captured by the finger reader.

### 13.03: Smart Doorbell Switch Transmits Captured Badge Information of the Visitor+Smart Doorbell Switch Information to the Central Server

After the Smart Doorbell Switch has scanned the Badge and captured information from the Badge, the Smart Doorbell Switch transmits the captured information to the Central Server. Also sent to the central server is the information associated with the Smart Doorbell Switch such as its location and time of activation.

### 13.04: Central Server Identifies the Received Badge Information

The central server looks for a match for the received Badge Information in its database.

### 13.05: Central Server Checks if Badge Information is in the Alert Database and Retrieves Available Information

The Central Server also checks to see if the Badge Information has a match in the Alert Database. If there is a match in the Alert Database, the Central Server will retrieve any information available on that Badge Information and its alert.

### 13.06: Results of the Alert Database Check are Analyzed to Determine the Next Step.

If a Badge Information match is found between the visitor and the Alert Database:

### 13.07: Central Server Transmits Alert Information to the Appropriate Authority

When the central server determines that the visitor's Badge Information is in an Alert Database, the central server sends an Alert Message to the appropriate authority associated with the alert. This Alert Message will include, at a minimum, the visitor's alert information, the time they pressed the Smart Doorbell Switch, and the address associated with the Smart Doorbell Switch that sent the Badge Information to the Central Server. Any other available information related to that visitor from the central server will also be provided. For example: If a visitor is in the FBI wanted list, an Alert Message is sent to the FBI telling them that the identified person who is in their wanted list is at the address associated with the Smart Doorbell they activated at whatever time they are there. If a person is wanted or dangerous, their Alert profile in the Alert Database can be set so that the appropriate local authorities will be contacted to ensure the resident's safety and possible capture of the visitor.

13.08: Central Server Transmits Alert Message to Smart Doorbell Associated with the Smart Doorbell Switch

In addition, when the central server determines that the identified visitor is in an Alert Database, the Central Server sends an Alert Message to the Smart Doorbell that sent the Badge Information. There are a wide range of Alert Messages that may be sent. For example: the alert message may state, “Fugitive at the Door, Please do not open the door and take proper shelter”, “Authorities have been informed, Fugitive at the Door, please do not open the door and take proper shelter”, etc.

13.09: Smart Doorbell Plays the received Alert Message for the Resident

Once the Smart Doorbell receives the Alert Message from the Central Server, it plays the Alert Message for the resident. The resident should then act accordingly. If the resident is away and they have set the alert function on, they will be contacted with the alert by whatever means they have chosen and will know not to return immediately and to do so with caution when they do return. The Badge Information will be saved in the log if that option is set.

If a Badge Information match is not found between the visitor and the Alert Database:

### 13.10: Results of the Central Server Badge Information Database Check are Analyzed to Determine the Next Step.

If a Badge Information match is found between the visitor and the Central Server:

13.11: Central Server Transmits Visitor Identifying Information to Smart Doorbell Associated with the Smart Doorbell Switch

When a match is found on the Central Server and not on the Alert Database, the Central Server transmits the identifying information tied with the received Badge Information to the Smart Doorbell that sent that Badge Information.

13.13: Smart Doorbell plays received Visitor Identifying Information for the Resident

If identifying information is found on the Central Server in relation to a Badge Information, it is given to the resident. The Smart Doorbell notifies the resident of who is at the door by reciting the received information. The Badge Information will still be saved in the log if that option is set. If no one is home and they have set the alert function on, the resident will be notified via whatever means they have chosen.

If a Badge Information match is not found between the visitor and the Central Server:

13.12: Central Server Transmits Default Visitor Identifying Information to Smart Doorbell Associated with the Smart Doorbell Switch

When a match is not found on either the Central Server or the Alert Database, the Central Server transmits a default message to the Smart Doorbell that sent that Badge Information. The default message will state that the visitor cannot be identified.

13.13: Smart Doorbell plays received Visitor Identifying Information for the Resident

When identifying information is not found on either the Central Server or the in-house database, the Smart Doorbell notifies the resident of the unidentified visitor by reciting the default message once it is received. If no one is home and they have set the alert function on, the resident will be notified via whatever means they have chosen that an unidentified visitor was at the door. The Badge Information will still be saved in the log if that option is set. The resident may also save the Badge Information in their Database at this point if they wish to do so.

### FIG. 14

### 14.01: Visitor Activates Smart Doorbell Switch

The visitor may activate the Smart Doorbell Switch in a variety of ways. When the visitor gently presses/touches the Smart Doorbell Switch with their badge or slides their card, the Smart Doorbell Switch is activated and triggered to take further action. Badge information can be saved by the issuer who can be a resident, property manager, employer, government agency etc. The Badge Information can be personal, proprietary and/or public. The Badge Information can be saved on a Badge Information Database on a local or remote servers.

### 14.02: Smart Doorbell Switch Scans and Captures Badge Information of the Visitor

Once the Smart Doorbell Switch is activated by the visitor placing their badge on the Smart Doorbell Switch or sliding their card, the visitor's Badge Information is then scanned and captured by the finger reader.

### 14.03: Smart Doorbell Switch Transmits Captured Badge Information of the Visitor to the Smart Doorbell

After the Smart Doorbell Switch has scanned the Badge and captured information from the Badge, the Smart Doorbell Switch transmits the captured Badge Information to the Smart Doorbell.

### 14.04: Smart Doorbell Identifies the Received Badge Information

When the Smart Doorbell receives the Badge Information from the Smart Doorbell Switch, the Smart Doorbell searches its in-house database to find a match for the received Badge Information. This in-house database is made up of previous Badge Information that were saved by the resident. The resident has an option of having their database viewable in an online account. This online account is connected to their Smart Doorbell and has all their Badge Information along with any saved information. The resident may edit entries in their database through this system if they do not wish to do it from their Smart Doorbell console. They also have the option of sending or receiving entries. If someone has an entry that someone else hasn't made yet, they may send them that entry. By doing so, they will get that entry's saved Badge Information and whatever saved information the sender wishes to share. Using the online account, people may also send their own Badge Information and associated identifying information so that others have it in their database. If someone has multiple homes, they may link all of their Smart Doorbells via an online account. The online account eases the process of making a database of Badge Information and allows sharing of entries. It may also be used for maintenance of the Smart Doorbell and for changing settings of the Smart Doorbell if the resident does not wish to use the Smart Doorbell console.

### 14.05: Results of the In-House Database Search are Analyzed to Determine the Next Step.

If a Badge Information match is found between the visitor and the in-house database:

### 14.06: Smart Doorbell Retrieves and Plays Identified Visitor Information for the Resident

If a Badge Information match is found in the in-house Badge Information database, the Smart Doorbell retrieves the saved information of the visitor associated with the identified Badge Information. The Smart Doorbell then notifies the resident at the premise of who is at the door by reciting the retrieved identifying information of the visitor. The resident has the option of setting the Smart Doorbell to keep a log of all visitors. When a match is found in the in-house database, the log will keep track of the information retrieved as well as what time and on what day that visitor was there. This can be useful for security purposes or for informing the premise resident of who visited their premise when they were away. The premise resident will have an option of turning on an alert system to inform them, via SMS, email, or phone call, of who visited their premise while they were away. They may also choose to have any combination of the three. If the resident is away and they set the alert function on, when someone rings the bell, an alert will instantly be sent, via whatever means was chosen, to the resident or resident's who are away.

If a Badge Information match is not found between the visitor and the in-house database:

### 14.07: Smart Doorbell Transmits Received Badge Information of the Visitor to the Central Server

If no match is found by the Smart Doorbell, the Smart Doorbell transmits the received Badge Information to the central server which contains a database comprised of data from a wide genre of sources such as Government agencies, private companies, and security providing agencies. People may also send their Badge Information and information to this central server via their online account so that when they ring a Smart Doorbell, their information is available. These agencies can provide their Badge Information and associated person information. These agencies, mainly the government and security providing ones, may also provide alert information connected with a Badge Information to alert the premise resident that the visitor may be a threat. This also gives the Government, security agencies, and others the ability to set up an alert list within the database with an added feature so that if any person on the alert list rings a bell, appropriate authorities can be notified. This can help keep residents safe and also help authorities catch anyone they are looking for.

### 14.08: Central Server Identifies the Received Badge Information

The central server looks for a match for the received Badge Information in its database.

### 14.09: Central Server Checks if Badge Information is in Alert Database and Retrieves Available Information

The Central Server also checks to see if the Badge Information has a match in the Alert Database. If there is a match in the Alert Database, the Central Server will retrieve any information available on that Badge Information and its alert.

### 14.10: Results of the Alert Database Check are Analyzed to Determine the Next Step.

If a Badge Information match is found between the visitor and the Alert Database:

### 14.11: Central Server Transmits Alert Information to the Appropriate Authority

When the central server determines that the visitor's Badge Information is in an Alert Database, the central server sends an Alert Message to the appropriate authority associated with the alert. This Alert Message will include, at a minimum, the visitor's alert information, the time they pressed the Smart Doorbell, and the address associated with the Smart Doorbell that sent the Badge Information to the Central Server. Any other available information related to that visitor from the central server will also be provided. For example: If a visitor is in the FBI wanted list, an Alert Message is sent to the FBI telling them that the identified person who is in their wanted list is at the address associated with the Smart Doorbell they activated at whatever time they are there. If a person is wanted or dangerous, their Alert profile in the Alert Database can be set so that the appropriate local authorities will be contacted to ensure safety and possible capture.

### 14.12: Central Server Transmits Alert Message to the Smart Doorbell

In addition, when the central server determines that the identified visitor is in an Alert Database, the Central Server sends an Alert Message to the Smart Doorbell that sent the Badge Information. There are a wide range of Alert Messages that may be sent. For example: the alert message may state, “Fugitive at the Door, Please do not open the door and take proper shelter”, “Authorities have been informed, Fugitive at the Door, please do not open the door and take proper shelter”, etc.

### 14.13: Smart Doorbell Plays the Received Alert Message for the Resident

Once the Smart Doorbell receives the Alert Message from the Central Server, it plays the Alert Message for the resident. The resident should then act accordingly. If the resident is away and they have set the alert function on, they will be contacted with the alert by whatever means they have chosen and will know not to return immediately and to do so with caution when they do return. If for any reason the resident wishes to save the Badge Information of the visitor, they may do so, however, they will get a warning message from their Smart Doorbell first stating that there is an alert for that visitor. If the resident is away, they will also have the ability to save the Badge Information when they return. The Badge Information will still be saved in the log if that option is set.

If a Badge Information match is not found between the visitor and the Alert Database:

### 14.14: Results of the Central Server Badge Information Database Check are Analyzed to Determine the Next Step.

If a Badge Information match is found between the visitor and the Central Server:

### 14.15: Central Server Transmits Visitor Identifying Information to the Smart Doorbell

When a match is found on the Central Server and not on the Alert Database, the Central Server transmits the identifying information tied with the received Badge Information to the Smart Doorbell that sent that Badge Information.

### 14.17: Smart Doorbell Plays Received Visitor Identifying Information for the Resident

If identifying information is found on the Central Server in relation to a Badge Information, it is given to the resident. The Smart Doorbell notifies the resident of who is at the door by reciting the received information as well as telling them that the visitor was identified by the Central Server. The resident then has the option of saving that Badge Information in their database. This will allow faster identification of that visitor next time they visit. The Badge Information will still be saved in the log if that option is set. If no one is home and they have set the alert function on, the resident will be notified via whatever means they have chosen. They will be able to save the Badge Information in the database when they return home if they know the visitor and are comfortable with giving them an entry.

If a Badge Information match is not found between the visitor and the Central Server:

### 14.16: Central Server Transmits Default Visitor Identifying Information to the Smart Doorbell

When a match is not found on either the Central Server or the Alert Database, the Central Server transmits a default message to the Smart Doorbell that sent that Badge Information. The default message will state that the visitor cannot be identified via the in-house database or via the Central Server.

14.17: Smart Doorbell plays received Visitor Identifying Information for the Resident

When identifying information is not found on either the Central Server or the in-house database, the Smart Doorbell notifies the resident of the unidentified visitor by reciting the default message once it is received. The resident then has the option of saving that Badge Information in their database. This will allow faster identification of that visitor next time they visit. If no one is home and they have set the alert function on, the resident will be notified via whatever means they have chosen that an unidentified visitor was at the door. The Badge Information will still be saved in the log if that option is set.

It would be obvious that as new technologies emerge, components of the invention can be replaced with the newer technology.

### FIG. 15

### 15.01: Visitor Activates Smart Doorbell Switch

The visitor may activate the Smart Doorbell Switch in a variety of ways. When the visitor gently presses/touches the Smart Doorbell Switch with their badge or slides their card, the Smart Doorbell Switch is activated and triggered to take further action. Badge information can be saved by the issuer who can be a resident, property manager, employer, government agency etc. The Badge Information can be personal, proprietary and/or public. The Badge Information can be saved on a Badge Information Database on a local or remote servers.

### 15.02: Smart Doorbell Switch Scans and Captures Badge Information of the Visitor

Once the Smart Doorbell Switch is activated by the visitor placing their badge on the Smart Doorbell Switch or sliding their card, the visitor's Badge Information is then scanned and captured by the finger reader.

### 15.03: Smart Doorbell Switch Transmits Captured Badge Information of the Visitor to the Smart Doorbell

After the Smart Doorbell Switch has scanned the Badge and captured information from the Badge, the Smart Doorbell Switch transmits the captured Badge Information to the Smart Doorbell.

### 15.04: Results of the Badge's Available Information Check are Analyzed to Determine the Next Step.

If information is available and received from the Badge:

### 15.05: Smart Doorbell Plays Received Visitor Information for the Resident

When information is available, the Smart Doorbell plays the received information for the visitor. If the badge is a work related badge and is being used during work time, the Badge information may contain the company name as part of the identifying information, and the Smart Doorbell will play that information along with other information for the resident. If the badge is issued by the Resident or is some other non work related badge, then the Smart Doorbell will play identifying information that is encoded on the Badge. If Badge Information contains an alert message, the Smart Doorbell plays the alert message for the resident. If no one is home and they have set the alert function on, the resident will be notified with the visitor identifying information via whatever means they have chosen. The visitor's identifying information will be saved in the log if that option is set.

If information is not available and identifying information is not received from the Badge:

### 15.06: Smart Doorbell Plays Default Message for the Resident

When information is not available, Smart Doorbell notifies the resident of the unidentified visitor by reciting a default message. The resident then has the option of saving that Badge Information in their database. This will allow faster identification of that visitor next time they visit. If no one is home and they have set the alert function on, the resident will be notified via whatever means they have chosen that an unidentified visitor was at the door. The Badge Information will still be saved in the log if that option is set.

1-3. (canceled)

4. A method for informing resident of a property identified information of a visitor comprising:
activation of a smart doorbell switch by the visitor wherein activation is done by the visitor pressing their finger on the smart doorbell switch;
said smart doorbell switch scans and captures fingerprint image of the visitor;
said smart doorbell switch transmits the fingerprint image to the Smart doorbell;
said smart doorbell identifies the received fingerprint image;
if the received fingerprint image is identified, said Smart doorbell retrieves and plays identified visitor information for the resident; and
if the received fingerprint image is not identified, said smart doorbell plays default message for the resident.

5. the method of claim 4 further comprising:
if visitor is identified to be in an alert database, said smart doorbell transmits alert information to appropriate authority;
said smart doorbell plays alert message for the resident.

6. the method of claim 4 further comprising:
if the received fingerprint image is not identified, said smart doorbell transmits received finger print image of the visitor to central server;
said central server identifies the received finger print image of the visitor;
if the received fingerprint image is identified, said central server retrieves and transmits visitor identifying information to the Smart doorbell;
said smart doorbell plays the received identifying visitor information for the resident; and
if the received fingerprint image is not identified, said central server transmits default visitor identifying information to the Smart doorbell;
said smart doorbell plays received default visitor identifying information for the resident.

7. the method of claim 4 further comprising:
if the received fingerprint image is not identified, said Smart doorbell plays default message for the resident.
if the received fingerprint image is identified, said smart doorbell determines if there is any message for the identified visitor
if there is message for the identified visitor, said smart doorbell retrieves and transmits the message for the identified visitor to the smart doorbell Switch
said Smart doorbell Switch plays the received message for the visitor

8. the method of claim 7 further comprising:
if the visitor wants to leave a message for the resident, said visitor leaves visitor leave the message for the resident using the smart doorbell switch;
said smart doorbell switch transmits the received message from the visitor to the smart doorbell;
said resident listens to the message left for the resident by the visitor by retrieving it from the smart doorbell.

9. the method of claim 4 further comprising:
said smart doorbell switch transmits the captured finger print image of the visitor and the Smart doorbell information to the central server;
said central server determines if the received finger print image is in the Alert Database and retrieves available information associated with the received finger print image;
if the received fingerprint image of the visitor is in the alert database, said central server transmits alert information to the appropriate authority;
central server transmits alert message to the Smart doorbell associated with the Smart doorbell Switch;
smart doorbell plays the received alert message for the resident;
if the received finger print image is not in the alert database, said central server identifies the received fingerprint image of the visitor;
if the received fingerprint image of the visitor is identified, said central server retrieves and transmits visitor identifying information to the Smart doorbell;
said Smart doorbell plays the received identifying visitor information for the resident; and
if the received fingerprint image of the visitor is not identified, said central server transmits default visitor identifying information to the Smart doorbell;
said Smart doorbell plays received default visitor identifying information for the resident.
